(19) United States
(12) Patent Application Publication
(10) Pub. No.: US 2011/0113227 A1
(43) Pub. Date: May 12, 2011

(54) ELECTRONIC EQUIPMENT AND BOOT METHOD, STORAGE MEDIUM THEREOF

(75) Inventors: Ying-Chih Lu, Taipei (TW); Yu-Hui Wang, Taipei (TW)

(73) Assignee: INVENTEC CORPORATION, Taipei (TW)

(21) Appl. No.: 12/761,192

(22) Filed: Apr. 15, 2010

(30) Foreign Application Priority Data
Nov. 6, 2009 (TW) 098137712

(51) Int. Cl. G06F 9/00

(52) U.S. Cl. 713/2

(57) ABSTRACT

An electronic equipment is provided, which includes a plurality of boot devices and a basic input/output system (BIOS). The BIOS is electrically coupled to the boot devices and used for recording driving parameters of the boot devices and a driving sequence of the driving parameters. The BIOS drives the boot devices by using the driving parameters according to the driving sequence, so as to perform a system booting operation of the electronic equipment. When any one of the boot devices accomplishes the system booting operation, the BIOS adjusts a driving parameter corresponding to the boot device as a first order of the driving sequence, so that the boot device becomes a first selected system booting device. Furthermore, a boot method for an electronic equipment and a storage medium thereof are provided.

### CROSS-REFERENCE TO RELATED PATENT APPLICATION

This application claims priority to and the benefit of Taiwan Patent Application No. 098137712, filed Nov. 6, 2009, the contents of which are incorporated herein in their entireties by reference.

### BACKGROUND OF THE INVENTION

1. Field of Invention

The present invention relates to an electronic equipment, and more particularly to an electronic equipment capable of automatically adjusting a boot device that accomplishes a booting operation of an operating system (OS) as a first priority boot device in a boot menu and a boot method and a storage medium thereof.

2. Related Art

With the rapid progress of the technology, the electronic equipment currently available on the market has various functions, which, however, also means that the electronic equipment needs to perform more program operations to execute more multimedia functions. In order to execute the above multimedia functions, an operating system (OS) usually needs to be installed on the electronic equipment. Generally speaking, when a user pushes a power button of the electronic equipment to perform booting, a power-on self test (POST) of a basic input/output system (BIOS) is first entered. In this procedure, the user can enter a user setting mode of the BIOS by pressing special keys, that is, so-called hot keys, so that the user can set driving parameters associated with the hardware connected to the electronic equipment, for example, the user often sets a boot order of boot devices in a boot menu in this setting mode. For example, when boot devices such as a hard disk drive (HDD), a compact disc read-only memory (CD-ROM) drive, or a universal serial bus (USB) device are installed on the electronic equipment of the user, the user may set in a boot menu a boot order of the boot devices through which the electronic equipment enters the OS. For example, when the user sets the HDD as a first priority boot order, the CD-ROM drive as a second priority boot order, and the USB device as a third priority boot order in the boot menu, subsequently each time when the electronic equipment of the user is booted once again, the BIOS sequentially inspects which one of the three boot devices has a boot loader according to the settings, so as to help the electronic equipment to enter the OS. That is to say, if neither the HDD nor the CD-ROM drive in the first and second priority boot orders has a boot loader and only the USB device has a boot loader, the electronic equipment enters the OS through the boot loader of the USB device.

According to the above, each time when the electronic equipment is booted, if the user only wants to use the boot loader of the USB device to enable the electronic equipment to enter the OS, the BIOS still wastes extra time on detecting whether the HDD and the CD-ROM drive in the first and second priority boot orders have the boot loader (unless the user enters the boot menu again to set the USB device as the first priority boot order), thereby causing unnecessary time waste.

### SUMMARY OF THE INVENTION

In view of the above, the present invention is directed to an electronic equipment capable of automatically adjusting a boot device that accomplishes a booting operation of an OS as a first priority boot device in a boot menu and a boot method and a storage medium thereof.

According to the above objectives, the present invention provides a boot method for an electronic equipment. The electronic equipment includes a plurality of boot devices. The method includes: providing a boot menu that records driving parameters of the boot devices and a driving sequence of the driving parameters; driving the boot devices by using the driving parameters according to the driving sequence, so as to perform a system booting operation of the electronic equipment; when the boot devices fail to accomplish the system booting operation, terminating the system booting operation; and when any one of the boot devices accomplishes the system booting operation, adjusting a driving parameter corresponding to the boot device as a first order of the driving sequence, so that the boot device becomes a first selected system booting device.

According to an embodiment of the present invention, the boot method for the electronic equipment further includes the following step. When the boot devices fail to accomplish the system booting operation, an order of the driving parameters of the boot devices in the driving sequence maintains unchanged.

According to an embodiment of the present invention, after the step of providing the boot menu, the boot method for the electronic equipment further includes: inputting a device setting command to set the driving sequence of the driving parameters. The device setting command includes a device add instruction, a device delete instruction, and a device sequence change instruction. The device add instruction is used for adding a driving parameter of a newly-added boot device to the boot menu. The device delete instruction is used for deleting a designated boot device from the boot menu. The device sequence change instruction is used for adjusting the driving sequence of the driving parameters.

According to the above objectives, the present invention further provides an electronic equipment, which includes a plurality of boot devices and a BIOS. The BIOS is electrically coupled to the boot devices and used for recording driving parameters of the boot devices and a driving sequence of the driving parameters. The BIOS drives the boot devices by using the driving parameters according to the driving sequence, so as to perform a system booting operation of the electronic equipment. When any one of the boot devices accomplishes the system booting operation, the BIOS adjusts a driving parameter corresponding to the boot device as a first order of the driving sequence, so that the boot device becomes a first selected system booting device.

In the electronic equipment according to an embodiment of the present invention, the boot devices include at least one of an HDD, a floppy drive, a CD-ROM drive, a USB device, a network boot device, a disk-on-chip device, or a storage device.

According to the above objectives, the present invention further provides a computer accessible storage medium, which is used for storing a computer program. When the computer program is executed by an electronic equipment, the electronic equipment accomplishes a method of booting an OS. The electronic equipment includes a plurality of boot devices. The method includes: providing a boot menu that records driving parameters of the boot devices and a driving sequence of the driving parameters; driving the boot devices by using the driving parameters according to the driving sequence, so as to perform a system booting operation of the electronic equipment; when the boot devices fail to accomplish the system booting operation, terminating the system booting operation; and when any one of the boot devices accomplishes the system booting operation, adjusting a driving parameter corresponding to the boot device as a first order of the driving sequence, so that the boot device becomes a first selected system booting device.

In the computer accessible storage medium according to an embodiment of the present invention, the method further includes the following step. When the boot devices fail to accomplish the system booting operation, an order of the driving parameters of the boot devices in the driving sequence maintains unchanged.

In the computer accessible storage medium according to an embodiment of the present invention, after the step of providing the boot menu, the method further includes: inputting a device setting command to set the driving sequence of the driving parameters. The device setting command includes a device add instruction, a device delete instruction, and a device sequence change instruction. The device add instruction is used for adding a driving parameter of a newly-added boot device to the boot menu. The device delete instruction is used for deleting a designated boot device from the boot menu. The device sequence change instruction is used for adjusting the driving sequence of the driving parameters.

The present invention is based on time locality when the user selects the boot device. If the OS is booted from a certain device, a chance of booting the OS through the same boot device at the next time is much higher. Therefore, an efficacy of the present invention is that, the boot device that accomplishes the booting operation of the OS is automatically adjusted as a first priority boot device in the boot menu, so that the electronic equipment can enter the OS directly through the boot device each time when it is booted, so as to prevent the user from wasting time on entering the boot menu again to set the boot device as the first priority boot order. Furthermore, the BIOS wastes no extra time on inspecting whether other boot devices have the OS boot loader, so that the booting procedure of the electronic equipment becomes much faster.

### BRIEF DESCRIPTION OF THE DRAWINGS

FIG. 1 is a schematic block diagram of an electronic equipment according to an embodiment of the present invention;

FIG. 2 is a schematic view illustrating that the electronic equipment in FIG. 1 enters a boot menu of a BIOS;

FIG. 3 is a flow chart of a boot method for an electronic equipment according to the present invention;

FIG. 4A is a schematic view after a user sets a driving sequence of boot devices in the boot menu in FIG. 2;

FIG. 4B is a schematic view illustrating that an HDD in FIG. 4A is automatically adjusted as a first priority boot device by a BIOS;

FIG. 5A is a schematic view illustrating that a user adds a boot device through an add instruction in FIG. 2; and

FIG. 5B is a schematic view illustrating that a user deletes a boot device in the boot menu through a delete instruction in FIG. 2.

### DETAILED DESCRIPTION OF THE INVENTION

In order to make the objectives, features, and advantages of the present invention more comprehensible, the embodiments of the present invention are illustrated below in detail with reference to the accompanying drawings.

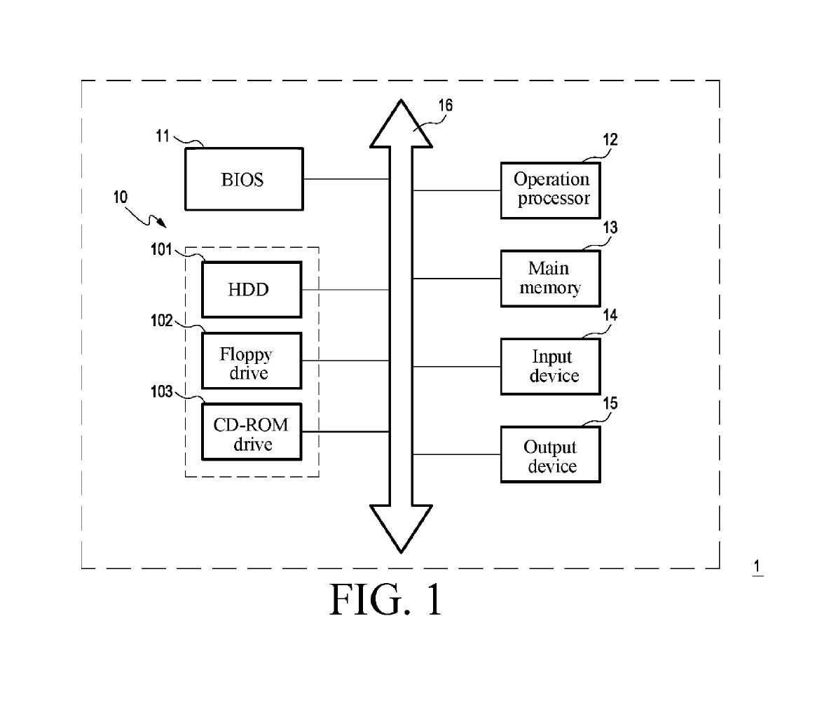

FIG. 1 is a schematic block diagram of an electronic equipment according to an embodiment of the present invention. Referring to FIG. 1, an electronic equipment 1 includes a plurality of boot devices 10 and a BIOS 11. In order to make the operation principles of the electronic equipment 1 according to the present invention be easily understood, an operation processor 12, a main memory 13, an input device 14, and an output device 15 of the electronic equipment 1 are also shown in FIG. 1. The plurality of boot devices 10, the BIOS 11, the operation processor 12, the main memory 13, the input device 14, and the output device 15 transmit program instructions or signal data between each other via a data transmission bus 16. Through the data transmission bus 16, the software and the hardware of the electronic equipment 1 can operate together in a mutual coordination mode.

Each boot device has a memory unit for storing an OS (for example, Microsoft Windows series of operating systems) and an OS boot loader. Therefore, the electronic equipment 1 may inspect each boot device to see whether the boot device has the OS boot loader, so as to perform a system booting operation. The OS stored in each boot device may be the same or different, for example, different OSes (such as the Windows XP or the Windows Vista) may exist. In this embodiment, the boot devices are illustrated by using, for example, an HDD 101 (such as an SATA HDD, an SCSI HDD, or an SAS HDD), a floppy drive 102, and a CD-ROM drive 103, and definitely, a plug-and-play device (for example, a USB device) may also be used. It should be noted that, the floppy drive 102 and the CD-ROM drive 103 use magnetic disks and optical disks as the memory units thereof.

The BIOS 11 is electrically coupled to the boot devices via the data transmission bus 16. The BIOS 11 is usually a program instruction stored in a memory unit of the electronic equipment 1, in which the memory unit here is a ROM or a flash memory. The BIOS 11 is used for preliminarily detecting whether all hardware equipments of the electronic equipment 1 are normally installed, that is, so-called POST, when the user powers on the electronic equipment 1 to enter a booting procedure of the electronic equipment 1. If the POST procedure is successful, the BIOS 11 inspects each boot device to see whether the boot device has the OS boot loader, so as to help the electronic equipment 1 to enter the OS, which is further illustrated below with reference to the accompanying drawings.

The operation processor 12 is a central control unit of the electronic equipment 1, which is in charge of operation processing of related signal data between the software and the hardware of the electronic equipment 1. The main memory 13 is used for storing some program instructions and data being executed or to be processed when the electronic equipment 1 executes a program instruction, so as to share the working load of the operation processor 12 temporarily. Additionally, the input device 14 may be, for example, a keyboard, and the output device 15 may be, for example, a screen.

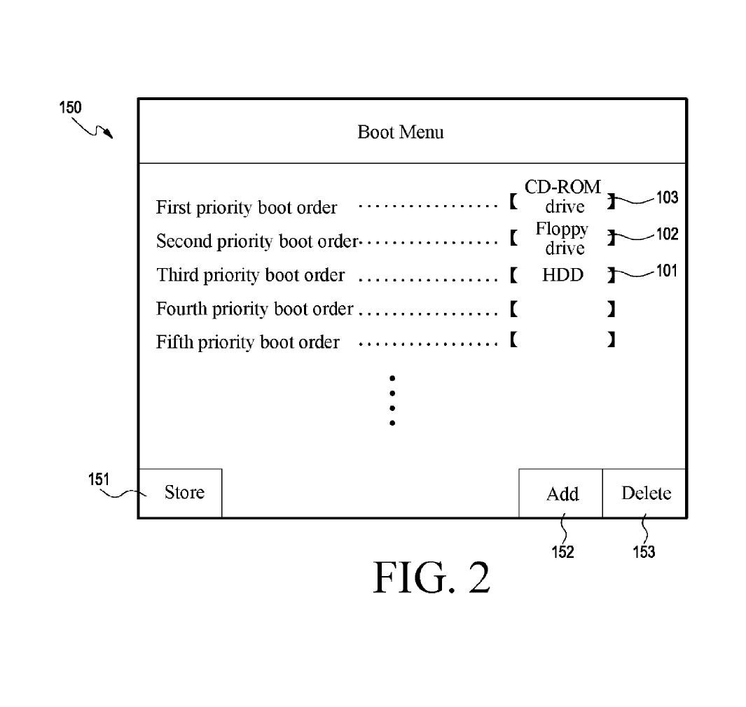

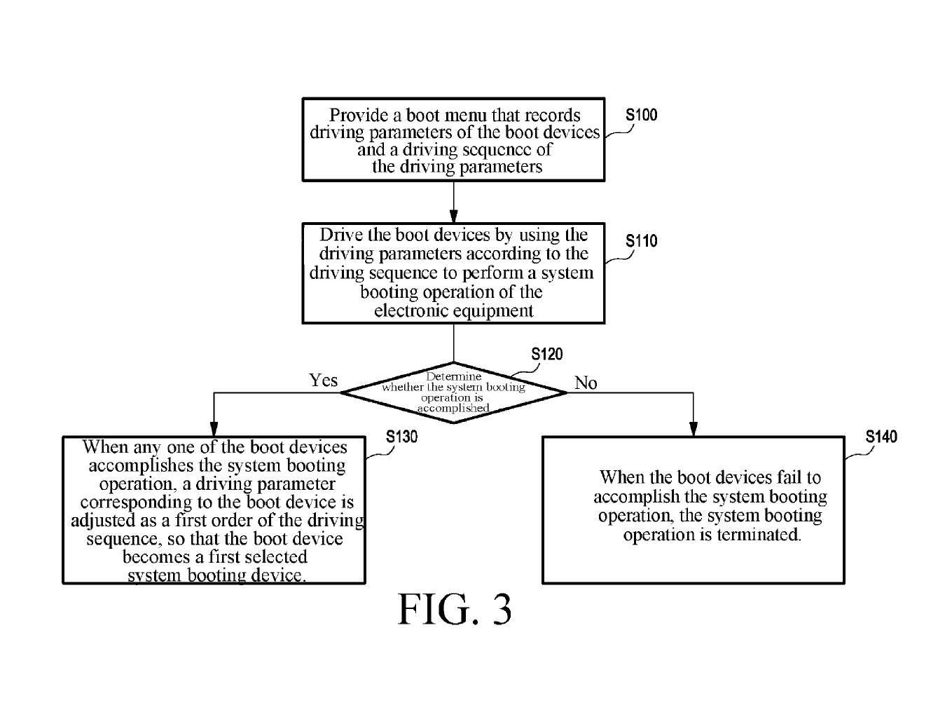

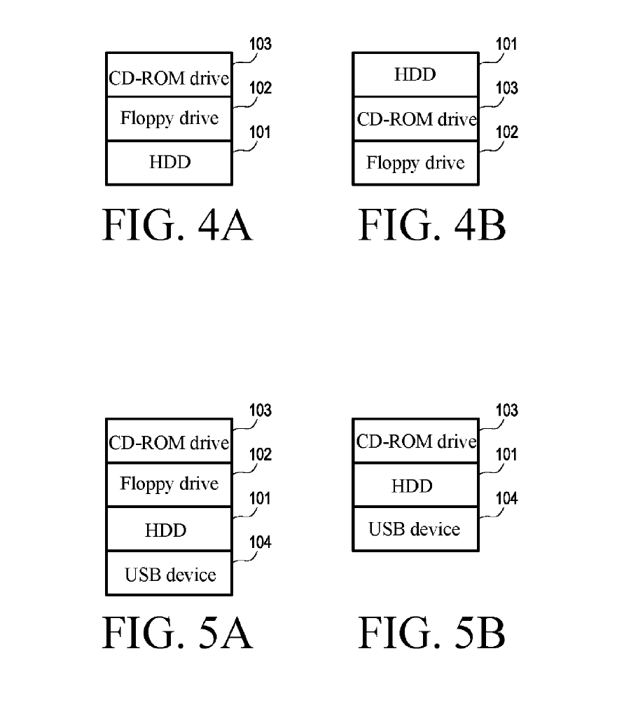

Referring to FIGS. 2 and 3 together with FIGS. 4A and 4B, FIG. 2 is a schematic view illustrating that the electronic equipment in FIG. 1 enters a boot menu of a BIOS; FIG. 3 is a flow chart of a boot method for an electronic equipment according to the present invention; FIG. 4A is a schematic view after a user sets a driving sequence of boot devices in the boot menu in FIG. 2; and FIG. 4B is a schematic view illustrating that an HDD in FIG. 4A is automatically adjusted as a first priority boot device by a BIOS.

When the electronic equipment 1 enters a booting procedure and intends to boot an OS, the user can input an instruction through the input device 14. At this time, the BIOS 11 executes the following steps.

A boot menu is provided, which records driving parameters of the boot devices and a driving sequence of the driving parameters (S100).

In this step, the user needs to push a power button of the electronic equipment 1 to enable the electronic equipment 1 to enter a booting procedure. In the practical operation, the user may press so-called hot keys on the input device 14 (for example, keyboard) in the booting procedure, so as to enter a user setting mode of the BIOS 11. The user setting mode includes a pre-stored boot menu 150. The boot menu 150 is displayed through the output device 15 (for example, screen). The boot menu 150 enables the user to input a device setting command, so as to set a booting sequence of driving parameters of the boot devices in the boot menu 150. The device setting command includes a device sequence change instruction, a store instruction 151, an add instruction 152, and a delete instruction 153.

Therefore, the user can execute the device sequence change instruction on the boot menu 150 through the input device 14, so as to directly set a driving sequence of the boot devices (this part falls in a technical scope apparent to persons skilled in the art, so that the description thereof is omitted here). For example, the user sets the CD-ROM drive 103 as a first priority boot order, the floppy drive 102 as a second priority boot order, and the HDD 101 as a third priority boot order. Subsequently, the store instruction 151 is executed, so as to record the settings of the driving sequence.

When the electronic equipment 1 is booted by the user this time or for a second time, the following step is performed. The boot devices are driven by using the driving parameters according to the driving sequence to perform a system booting operation of the electronic equipment (S110).

In this step, when the electronic equipment 1 is booted again by the user this time or for a second time and enters a booting procedure, after the BIOS 11 accomplishes the POST, the BIOS 11 enters a determination procedure according to the recorded driving parameters, so as to determine whether the system booting operation is accomplished (S120).

In this step, the BIOS 11 sequentially inspects whether the CD-ROM drive 103, the floppy drive 102, and the HDD 101 store an OS boot loader. In this embodiment, it is assumed that merely the HDD 101 stores an OS boot loader, so that the electronic equipment 1 enters the OS through the HDD 101, thereby accomplishing the OS booting operation. Subsequently, the BIOS 11 hands over a control right of the procedure after entering the OS to the operation processor 12 (this part is not the technical characteristics of the present invention, so that the description thereof is omitted here).

Subsequently, the BIOS 11 of the electronic equipment 1 performs the following step.

When any one of the boot devices accomplishes the system booting operation, a driving parameter corresponding to the boot device is adjusted as a first order of the driving sequence, so that the boot device becomes a first selected system booting device (S130).

In this step, in the driving sequence set and recorded on the boot menu 150 by the user, the driving parameter of the HDD 101 storing the OS boot loader is automatically adjusted by the BIOS 11 from the third priority boot order (as shown in FIG. 4A) to the first order of the driving sequence in the boot menu 150, that is, the first priority boot order (as shown in FIG. 4B), so that the HDD 101 serves as the first selected system booting device, and becomes the first priority boot device by which the electronic equipment boots the OS. The driving parameter of the CD-ROM drive 103 is automatically adjusted by the BIOS 11 from the original first priority boot order to the second priority boot order. In other words, the BIOS 11 can automatically adjust the boot device that successfully boots the OS last time as the first priority boot device of the electronic equipment 1 according to the so-called least recently used (LRU) operation rule. The LRU operation rule is based on time locality when the user selects the boot device. If the OS is booted through a certain device, a chance of booting the OS through the same boot device is much higher.

According to the above, if the user only wants to use the HDD 101 to enter the OS later on, the BIOS 11 is prevented from wasting extra time on inspecting whether the CD-ROM drive 103 or the floppy drive 102 stores the OS boot loader.

Additionally, when the BIOS 11 sequentially inspects whether the CD-ROM drive 103, the floppy drive 102, and the HDD 101 store the OS boot loader according to the driving sequence set and recorded by the user, the following step is performed.

When the boot devices fail to accomplish the system booting operation, the system booting operation is terminated (S140).

In this step, if the OS of the electronic equipment 1 fails to be booted, in principle, the BIOS 11 automatically terminates the system booting operation, and a booting order of the driving parameters of the boot devices containing no boot loader or the boot device containing the boot loader but failing to accomplish the booting operation maintains unchanged in a next driving sequence.

It should be noted that, although the plurality of boot devices 10 uses the HDD 101, the floppy drive 102, and the CD-ROM drive 103 as examples, the present invention is also applicable to the electronic equipment 1 having only two boot devices or having more than three boot devices, for example, including, but not limited to, at least one of pre-boot execution environment (PXE) booting for a USB device and a network boot device and an Internet SCSI (ISCSI) booting for the disk-on-chip device or the storage device, or other boot devices that can be used for booting the OS.

Referring to FIGS. 5A and 5B together with FIG. 2, FIG. 5A is a schematic view illustrating that a user adds a boot device through an add instruction in FIG. 2, and FIG. 5B is a schematic view illustrating that a user deletes a boot device in the boot menu through a delete instruction in FIG. 2.

Referring to FIGS. 5A and 2, when a boot device is added to the electronic equipment 1 of the user (here, taking the USB device 104 as an example), the user can add a newly-added boot device to the boot menu 150 through the add instruction 152, that is, add a driving parameter of the USB device 104 to the boot menu. The BIOS 11 automatically lists the driving parameter of the USB device 104 as the last boot order of the boot device driving sequence, as shown in FIG. 5A. Of course, the user can also randomly set the driving orders of the boot devices (the CD-ROM drive 103, the floppy drive 102, the HDD 101, and the USB device 104) in the boot menu 150 through the device sequence change instruction.

Referring to FIGS. 5B and 2, when the user intends to delete a certain boot device in the boot menu 150, the user can delete a driving parameter of a designated boot device (here, taking the floppy drive 102 in FIG. 5A as an example) from the boot menu 150 through the delete instruction 153. The BIOS 11 automatically changes the driving parameter of the HDD 101 from the third priority boot order to the second priority boot order (the driving parameter of the USB device 104 becomes the third priority boot order), as shown in FIG. 5B. Of course, similarly, the user can randomly set the driving orders of the boot devices (the CD-ROM drive 103, the HDD 101, and the USB device 104) in the boot menu 150 through the device sequence change instruction.

Furthermore, the boot method for the electronic equipment can also be stored in a computer accessible storage medium, that is to say, when the computer program stored in the computer accessible storage medium is executed by an electronic equipment having a plurality of boot devices, the electronic equipment accomplishes the above method for booting the OS. As the method has already been illustrated with reference to the accompanying drawings (referring to FIG. 3 for this part), the description thereof is omitted here for simplicity.

Based on the above, the electronic equipment and the boot method for the electronic equipment and the storage medium thereof according to the present invention have the following advantages. The boot device that accomplishes the booting operation of the OS is automatically adjusted as the first priority boot device in the boot driving sequence at the next time. Therefore, each time when the electronic equipment is booted, the BIOS is prevented from wasting extra time on inspecting whether each boot device stores the OS boot loader and trying to boot the OS through the boot device, so that the booting procedure of the electronic equipment becomes much faster.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A boot method for an electronic equipment, wherein the electronic equipment comprises a plurality of boot devices, the method comprising:
providing a boot menu that records driving parameters of the boot devices and a driving sequence of the driving parameters;
driving the boot devices by using the driving parameters according to the driving sequence to perform a system booting operation of the electronic equipment;
when the boot devices fail to accomplish the system booting operation, terminating the system booting operation; and
when any one of the boot devices accomplishes the system booting operation, adjusting a driving parameter corresponding to the boot device as a first order of the driving sequence, so that the boot device becomes a first selected system booting device.

2. The boot method for an electronic equipment according to claim 1, further comprising:
when the boot devices fail to accomplish the system booting operation, maintaining an order of the driving parameters of the boot devices in the driving sequence unchanged.

3. The boot method for an electronic equipment according to claim 1, wherein after the step of providing the boot menu, the method further comprises:
inputting a device setting command to set the driving sequence of the driving parameters.

4. The boot method for an electronic equipment according to claim 3, wherein the device setting command comprises a device add instruction, so as to add a driving parameter of a newly-added boot device to the boot menu.

5. The boot method for an electronic equipment according to claim 3, wherein the device setting command comprises a device delete instruction, so as to delete a designated boot device from the boot menu.

6. The boot method for an electronic equipment according to claim 3, wherein the device setting command comprises a device sequence change instruction, so as to adjust the driving sequence of the driving parameters.

7. An electronic equipment, comprising:
a plurality of boot devices; and
a basic input/output system (BIOS), electrically coupled to the boot devices, and used for recording driving parameters of the boot devices and a driving sequence of the driving parameters, driving the boot devices by using the driving parameters according to the driving sequence to perform a system booting operation of the electronic equipment, and when any one of the boot devices accomplishes the system booting operation, adjusting a driving parameter corresponding to the boot device as a first order of the driving sequence, so that the boot device becomes a first selected system booting device.

8. The electronic equipment according to claim 7, wherein the boot devices comprise at least one selected from a group consisting of a hard disk drive (HDD), a floppy drive, a compact disc read-only memory (CD-ROM) drive, a universal serial bus (USB) device, a network boot device, a disk-on-chip device, and a storage device.

9. A computer accessible storage medium, applicable to store a computer program, wherein when the computer program is executed by an electronic equipment, the electronic equipment accomplishes a method for booting an operating system (OS), and the electronic equipment comprises a plurality of boot devices, the method comprising:
providing a boot menu that records driving parameters of the boot devices and a driving sequence of the driving parameters;
driving the boot devices by using the driving parameters according to the driving sequence to perform a system booting operation of the electronic equipment;
when the boot devices fail to accomplish the system booting operation, terminating the system booting operation; and
when any one of the boot devices accomplishes the system booting operation, adjusting a driving parameter corresponding to the boot device as a first order of the driving sequence, so that the boot device becomes a first selected system booting device.

10. The computer accessible storage medium according to claim 9, wherein the method further comprises:
when the boot devices fail to accomplish the system booting operation, maintaining an order of the driving parameters of the boot devices in the driving sequence unchanged.

11. The computer accessible storage medium according to claim 9, wherein after the step of providing the boot menu, the method further comprises:
inputting a device setting command to set the driving sequence of the driving parameters.

12. The computer accessible storage medium according to claim 11, wherein the device setting command comprises a device add instruction, so as to add a driving parameter of a newly-added boot device to the boot menu.

13. The computer accessible storage medium according to claim 11, wherein the device setting command comprises a device delete instruction, so as to delete a designated boot device from the boot menu.

14. The computer accessible storage medium according to claim 11, wherein the device setting command comprises a device sequence change instruction, so as to adjust the driving sequence of the driving parameters.
